(19) United States
(12) Patent Application Publication
(10) Pub. No.: US 2004/0211722 A1
(43) Pub. Date: Oct. 28, 2004

(54) Wastewater treatment unit

(76) Inventor: Joe W. Lacey, Florence, MS (US)

Correspondence Address: LITMAN LAW OFFICES, LTD., P.O. BOX 15035 CRYSTAL CITY STATION, ARLINGTON, VA, 22215, US

(21) Appl. No.: 10/420,772

(22) Filed: Apr. 23, 2003

(51) Int. Cl. C02F 3/02

(52) U.S. Cl. 210/620

(57) ABSTRACT

The wastewater treatment unit includes a tank which in cross-section has a trapezoidal shaped lower portion and a rectangular upper portion. The tank has an opening into a hollow interior defined by a horizontal bottom wall and an upright peripheral wall extending from the bottom wall. A divider wall and a baffle are disposed vertically across the interior for subdividing the tank into a first aeration chamber, a second aeration chamber, and a clarification chamber. Wastewater flows from the first chamber into the second chamber through a conical shaped opening in the divider wall. The wastewater then flows into the clarification chamber in which solid matter is permitted to settle. The clarification chamber has a sloped floor and guiding wedges to return settled matter, or activated sludge, back to the center of the second chamber where turbulence is greatest.

### BACKGROUND OF THE INVENTION

1. Field of the Invention

The present invention relates to a wastewater treatment unit. More specifically, the invention relates to a wastewater treatment unit which treats wastewater using the biologically activated sludge process more efficiently than conventional treatment units.

2. Description of the Related Art

Ultimately, wastewater, or spent water, must be returned to the land, streams, or bodies of water. Considerable engineering research and development has focused on methods for removing contaminants from wastewater before it is released into the environment.

Aeration is a process used in nearly all types of wastewater treatment. Aeration is used to provide dissolved oxygen for biological oxidation of the organic matter by microorganisms. Aeration also facilitates release of certain volatile substances to the atmosphere and is effective in removing certain organic compounds by oxidation, such as phenols, sulfides and sulfites. Aeration may also be used to make a float sludge by adding buoyancy to sludge particles with bubbles of air.

Biological methods of waste treatment constitute the most common and widely used methods of waste treatment because they are the most economical means of accomplishing an acceptable final effluent. They utilize naturally occurring microorganisms to accomplish results which would be quite costly if attempted by chemical or mechanical means. The microorganisms are used to bring about a breakdown of complex organic compounds primarily by oxidation (and hydrolysis). Complete aerobic decomposition results in compounds which, under ordinary conditions of temperature and pressure, are stable., such as water, carbon dioxide, nitrogen, chlorides, nitrates, etc.

The most widely used aerobic process for bringing about stabilization in wastewater having organic matter constituents is the activated sludge method. The method depends on establishing and maintaining a population of biodegrading microorganisms and providing close contact of the degrading microorganisms and a supply of dissolved oxygen. The microorganisms feed and grow upon the oxidizable material in the wastewater and form a suspended floc of “activated sludge” in water. Air bubbled through the water or absorbed by constantly renewing the air-water interface (by agitation) replenishes the oxygen needed for the biological oxidation. The mixture of wastewater and activated sludge, known as “mixed liquor”, is then settled to separate the activated sludge solids from the treated water. The settled activated sludge is usually mechanically returned (by pump) to the aeration site.

There are many problems associated with the conventional activated sludge methods, which conventional treatment facilities have not been able to overcome. One such problem is sludge bulking. In sludge bulking, a large volume of light, fluffy sludge forms which does not settle, but merely floats in the water. Typically, sludge bulking is due to the presence of filamentous organisms. Their growth in excessive numbers causes the sludge to be less dense, and thereby float in the water. Another problem is rising sludge. The sludge is initially dense and settles well, but rises in chunks and floats on the surface of the water. Consequently, such complications make it difficult to achieve an acceptable final effluent.

U.S. Patent Application Publication No. 2002/0158011 A1, published Oct. 31, 2002, discloses a wastewater treating device which comprises a plurality of columns stacked in multi-levels, which are packed with microorganism carriers, wherein organic waste water is aerobically treated in the columns and is then discharged from the wastewater treating device. The area of a surface in the columns, at the wastewater discharging side is smaller than the area of a surface at the waste water introducing side.

U.S. Pat. No. 5,160,621, issued Nov. 3, 1992 to Y. Nagasaki et al., discloses a method for treatment of wastewater by an activated sludge process wherein the aeration tank system is composed of three tanks, while the aeration amount in the respective tanks is varied on the basis of the aeration amount in the first tank, and the pH value in the aeration tank system is made acidic rather than alkaline, as in the conventional method, whereupon the pH value in the first tank is made lowest and the pH value in the other tanks is made higher in the order of the second tank to the third tank.

U.S. Pat. No. 5,364,529, issued Nov. 15, 1994 to Morin et al., discloses a wastewater treatment system which has two chambers in which microbiological cultures grow aerobically, including a first chamber which receives wastewater to be treated and a second chamber which produces activated sludge The system also has a float sludge separator for removing from the system float sludge made with the aerobic culture from the first chamber, and an activated sludge separator for separating activated sludge and treated wastewater from the aerobic culture in the second chamber.

U.S. Pat. No. 5,874,003, issued Feb. 23, 1999 to B. L. Rose, discloses a wastewater treatment apparatus including a biotreatment tank and a floating clarifier within the tank. The floating clarifier includes a floating base and a perimeter wall mounted to and beneath the floating base. A plurality of tented panels mounted to the clarifier walls forms an apertured bottom of the floating clarifier having a plurality of tortuous outlets. The biotreated wastewater from the biotreatment tank enters the floating clarifier, where the suspended solids within the biotreated water settle and descend out of the apertured bottom of the clarifier.

U.S. Pat. No. 6,224,773, issued May 1, 2001 to C. Adams, Jr., discloses a wastewater treatment system. The wastewater treatment system has a tank and at least one baffle disposed in the tank so as to subdivide the tank to form a treatment chamber and a clarification or settling chamber. The baffle is inclined relative to vertical, so that the clarification chamber tapers from an upper end to a lower end. The lower end of the clarification chamber is provided with a plurality of mutually spaced orifices or apertures communicating with a lower region of the treatment chamber, so that sludge settling in the clarification chamber is directed to the lower region of the treatment chamber via the orifices. The clarification chamber is further provided at its lower end with a plurality of substantially vertical partitions defining a plurality of hoppers communicating with respective orifices for guiding sludge to the orifices. A recycle pump and a distribution manifold serve to recycle wastewater from the treatment chamber to the clarification chamber.

Other related patents include U.S. Patent Application Publication No. 2002/0096472A1, published Jul. 25, 2002 (wastewater treatment process); U.S. Patent Application Publication No. 2002/0144945 A1, published Oct. 10, 2002 (enhanced activated sludge treatment); U.S. Patent Application Publication No. 2003/0042199 A1, published Mar. 6, 2003 (wastewater treatment process); U.S. Pat. No. 3,964,998, issued Jun. 22, 1976 to J. Barnard (improvements in and relating to wastewater treatment); U.S. Pat. No. 5,172,781, issued Oct. 30, 1979 to J. D. Walk et al. (wastewater process for treatment of strong wastes); U.S. Pat. No. 4,315,823, issued Feb. 16, 1982 to Witt et al. (anaerobic treatment); U.S. Pat. No. 4,897,196, issued Jan. 30, 1990 to W. Copa et al.; U.S. Pat. No. 5,906,746, issued May 25, 1999 to K. Helmo et al. (method for the control of biodegradation); U.S. Pat. No. 5,958,241, issued Sep. 28, 1999 to R. DeBenedetto et al. (wastewater treatment and minimization system); U.S. Pat. No. 5,985,150, issued Nov. 16, 1999 to A. Vesprille et al. (process for the aerobic biological purification of water); U.S. Pat. No. 6,123,846, issued Sep. 26, 2000 to S. Kikuchi (activated sludge processing apparatus and method for control of sludge to be returned); U.S. Pat. No. 6,244,772 B1, issued May 1, 2001 to A. Golcz (activated sludge degassing process and device); U.S. Pat. No. 6,290,852 B1, issued Sep. 18, 2001 to W. Heine et al. (method and apparatus for the purification and/or treatment of commercial and/or industrial wastewaters); U.S. Pat. No. 6,325,933, issued Dec. 4, 2001 to M. Nielsen et al. (process for biological purification of wastewater under sludge retention); U.S. Pat. No. 6,344,142 B1, issued Feb. 5, 2002 to K. Yamasaki et al. (wastewater treatment method and apparatus); U.S. Pat. No. 6,372,138 B1, issued Apr. 16, 2002 to Y. Jae-hun Cho et al. (wastewater treatment method for removing organic matter and nitrogen, carrier used thereof and method for manufacturing the carrier; U.S. Pat. No. 6,379,545 B1, issued Apr. 30, 2002 to J. Perslow et al. (modular wastewater treatment system); U.S. Pat. No. 6,387,266 B1, issued May 14, 2002 to M. Drda (method of sewage biological purification and an equipment for performing this method); U.S. Pat. No. 6,485,646 B1, issued Nov. 26, 2002 to H. Dijkman (process for the treatment of wastewater containing ammonia); U.S. Pat. No. 6,488,854 B2, issued Dec. 3, 2002 to K. O'Leary et al. (activated sludge wastewater treatment system and method); U.S. Pat. No. 6,540,919, issued Apr. 1, 2003 to J. Held et al. (method of treating waste activated sludge using electroporation); UK Patent Application GB 2 057 415 (pressure aerating system for treating waste materials with active sludge); and EP Patent Application Publication No. 0 132 609 (biological wastewater treating system).

None of the above inventions and patents, taken either singly or in combination, is seen to describe the instant invention as claimed. Thus a wastewater treatment unit solving the aforementioned problems is desired.

### SUMMARY OF THE INVENTION

The wastewater treatment unit of the present invention utilizes naturally occurring microorganisms for providing treated wastewater that has more clarity and a significantly reduced suspended solids content than that produced by the prior art wastewater treatment facilities. The wastewater treatment facility of the present invention includes a tank which in cross-section has a trapezoidal shaped lower portion and a rectangular upper portion. The tank has a hollow interior defined by a horizontal bottom wall and an upright peripheral wall extending from the bottom wall. A divider wall and a baffle are disposed vertically across the recess and spaced apart from the first and second endwalls, respectively, for subdividing the tank into a first aeration chamber, a second aeration chamber, and a clarification chamber.

The first and second aeration chambers are each equally aerated. Wastewater entering the tank flows into the first chamber where it is aerated, then flows through a conical shaped opening in the divider wall by hydraulic displacement into the second chamber, where it is further aerated. The conical shaped opening and the air patterns which are formed in each chamber help retain solid matter within the first aeration chamber. The wastewater then flows into the clarification chamber in which there is no air flow and solid matter is permitted to settle. The clarification chamber has a sloped floor and guiding wedges on either side of the sloped floor to return settled matter, or activated sludge, back to the center of the second chamber where turbulence is greatest. The clarification chamber is also provided with a T-shaped clarifier conduit and an effluent conduit which extends out of the tank. The T-shaped clarifier conduit and effluent conduit are configured to help prevent solids floating within the wastewater from leaving the tank.

Accordingly, it is a principal object of the invention to provide a wastewater treatment unit which produces high quality effluent with minimal suspended solids content.

It is another object of the invention to provide a wastewater treatment unit having two aeration chambers which are equally aerated.

It is a further object of the invention to return activated sludge to a central area of the aeration chamber, where turbulence is greatest.

Still another object of the invention is to provide a conduit which is configured to allow treated wastewater to leave the tank and to retain in the tank suspended solids floating within the wastewater.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a wastewater treatment unit disposed under a ground surface according to the present invention.

FIG. 2 is a plan view of a wastewater treatment unit according to the present invention, the lid being removed.

FIG. 3 is a sectional view of a wastewater treatment unit according to the present invention drawn along lines 3-3 of FIG. 2.

FIG. 4 is a sectional view of a wastewater treatment unit according to the present invention drawn along lines 4-4 of FIG. 3.

Similar reference characters denote corresponding features consistently throughout the attached drawings.

### DETAILED DESCRIPTION OF THE PREFERRED EMBODIMENTS

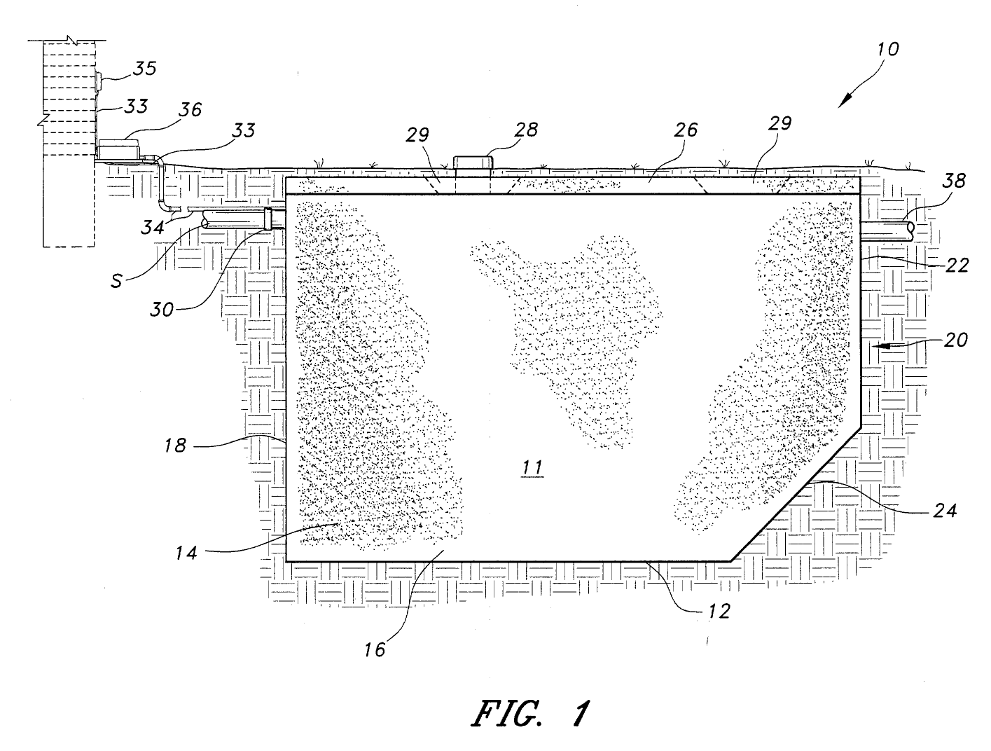

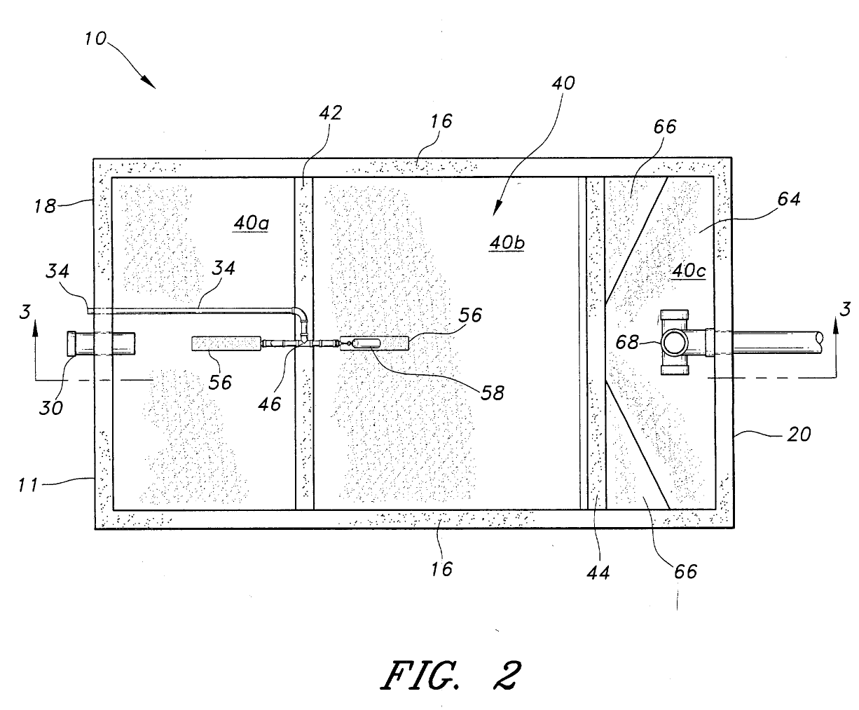

The present invention relates to a wastewater treatment unit, designated as 10 in the drawings. As can be seen in FIG. 1, the unit 10 includes a tank 11 which, in cross-section, has a trapezoidal shaped lower portion and a rectangular upper portion. The tank 11 is preferably placed beneath a ground surface as is shown. The tank 11 has a horizontal bottom wall 12 and an upright peripheral wall 14 which extends from the horizontal bottom wall 12. Referring to FIG. 2, the peripheral wall 14 includes parallel, opposing sidewalls 16 which extend between and connect first and second opposing endwalls, 18 and 20 respectively. The first endwall 18 is vertical and extends normal to the horizontal bottom wall 12. The second endwall 20 has a vertical upper portion 22 and an inclined lower portion 24 which slopes inward from the upper portion 22 and connects with the horizontal bottom wall 12 at an angle of approximately 135°.

The tank 11 has an influent inlet 30 which extends through the first endwall 18. The influent inlet 30 is connected to a sewage pipe S or other wastewater source, so that wastewater may enter the tank 11. Also extending through the first endwall 18 is an air tube 34 which allows air to be transmitted into the tank 11. The air tube 34 is connected to an aerator 36. The aerator 36 is disposed above ground level proximate the building or facility from which the wastewater exits. A supplementary tube 33 is connected to the air tube 34 and extends to a pressure controlled alarm 35. The supplementary tube 33 is preferably polyethylene tubing and is preferably connected to the air tube 34 with brass nipples or similar connector devices. The supplementary tube 33 allows some of the airflow from the air tube 34, to be directed to the alarm 35. The alarm 35 has a pressure switch which activates the alarm when a break in air pressure is detected. The alarm is preferably positioned proximate the aerator 36 and affixed to a wall or other support structure associated with the building or facility.

The tank 11 is also provided with a removable lid 26 or covering which can be placed over the peripheral wall 14. The lid 26 has a conventional riser 28 which protrudes above the ground surface. The riser 28 provides an opening through which one may look into the tank 11 while the tank 11 is underground. Also provided in the lid 26 are access doors 29. Access doors 29 cover additional openings in the lid 26 and can be removed to facilitate access into the tank 11 without removing the lid 29. An effluent outlet 38 extends through the second endwall 20 and permits treated wastewater to leave the tank 11.

FIG. 2 depicts a top view of the tank 11 with the lid 26 removed. As can be seen, the tank 11 has an interior 40 defined by the horizontal bottom wall 12 and the upright peripheral wall 14. A divider wall 42 and a baffle 44 are disposed vertically across the interior 40, defining three chambers. The divider wall 42 and the baffle 44 are spaced apart from the first and second endwalls 18 and 20 for subdividing the tank 11 into a first aeration chamber 40a, a second aeration chamber 40b, and a clarification chamber 40c. The first aeration chamber 40a is defined by the area between the first endwall 18 and the divider wall 42. The clarification chamber 40c is defined by the area between the baffle 44 and the second endwall 20. The second aeration chamber 40b is defined by the area between the divider wall 42 and the baffle 44 and is preferably larger than the first aeration chamber 40a and the clarification chamber 40c. The tank 11, the divider wall 42, and the baffle 44 can be made from any suitable material, including but not limited to concrete or asphalt coated steel.

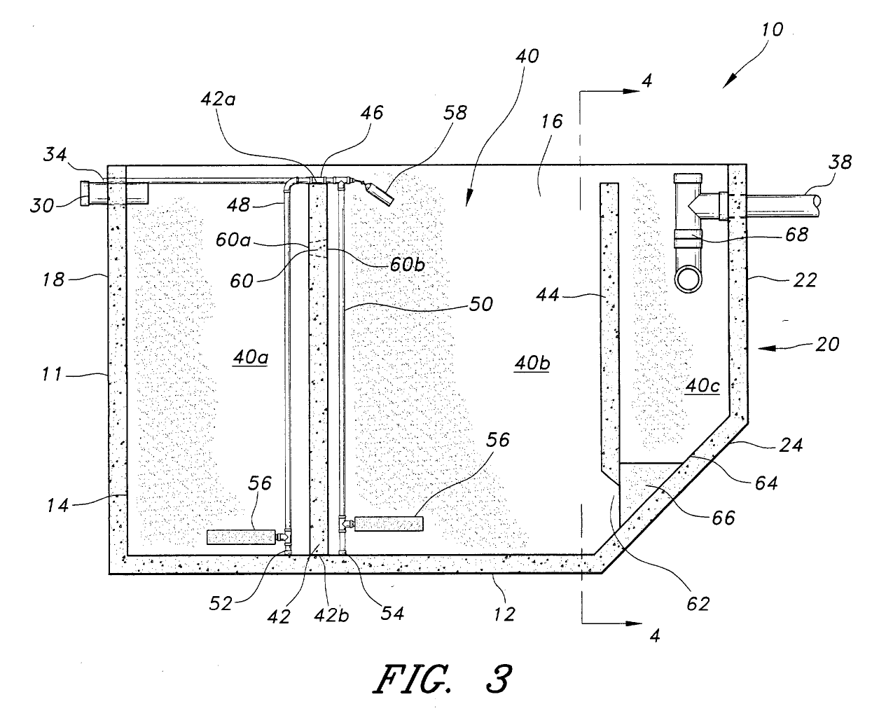

Referring to FIG. 3, it can be seen that the divider wall 42 includes a top end 42a and a bottom end 42b. The bottom end 42b of the divider wall 42 attaches to the horizontal bottom wall 12 of the tank 11 and separates the first aeration chamber 40a and the second aeration chamber 40b. The divider wall 42 has a conical shaped opening 60 defined therethrough. The opening 60 has a first smaller end 60a and a second, opposing larger end 60b. The first smaller end 60a of the opening 60 faces the first aeration chamber 40a, while the second, larger end 60b of the opening faces the second aeration chamber 40b.

A central input air manifold 46 is disposed upon the top end 42a of the divider wall 42. The air manifold 46 is a conduit which is capable of connecting with a plurality of additional conduits. Preferably, the manifold 46 is PVC piping that has a plurality of outlets. The air pipe 34, which extends from the aerator, connects with the manifold 46. The manifold is also directly connected to a high-level mechanical alarm float 58 and first and second aeration pipes, 48 and 50.

The mechanical alarm float 58 extends from the manifold 46 into the second aeration chamber. During high water conditions, the float 58 will rise and break pressure. When a pressure break is detected by the pressure controlled alarm 35, the alarm 35 is activated.

The first aeration pipe 48 extends from the manifold 46 into the first aeration chamber 40a and attaches to a first air diffuser platform 52. The first air diffuser platform 52 is mounted to the horizontal bottom wall 12. The first air diffuser platform is connected to an air diffuser 56. Similarly, the second aeration pipe 50 depends from the manifold 46 into the second aeration chamber 40b and attaches to a second air diffuser platform 54. The second air diffuser platform 54 is also mounted to the horizontal bottom wall 12 and connected to an air diffuser 56. The first and second aeration pipes, 48 and 50, and the first and second air diffuser platforms, 52 and 54, are preferably PVC piping, however, any other suitable material may be used.

The air diffuser platforms, 52 and 54, are mounted to the horizontal bottom wall 12 so that the air diffusers 56 do not float in the wastewater, but instead remain stationary at a predetermined height from the horizontal bottom wall 12. The height at which each air diffuser 56 should be elevated from the horizontal bottom wall 12 should be calculated by methods known in the art, to ensure equal turbulence in both aeration chambers. For example, the following formula can be used to calculate the appropriate height for each air diffuser 56:

$$p = \frac{F}{A} = \frac{ρ A h g}{A}$$

where P=pressure

Ah=volume of liquid (area A times height h)

ρ=density of liquid

F=force

g=acceleration of gravity.

As is shown, the second aeration chamber 40b is larger than the first aeration chamber 40a. Consequently, the air diffuser 56 in the first aeration chamber 40a is disposed at a lower elevation from the horizontal bottom wall 12 of the tank 11 than the air diffuser 56 in the second aeration chamber 40b to compensate for the greater pressure in the second chamber and thereby to allow equal turbulence in both chambers. The air diffusers 56 are preferably silica based air diffusers, however any suitable type of air diffuser may be used.

The air diffusers 56 are charged by air directed from the central input air manifold 46. The central air manifold 46 allows air to be distributed equally into both the first aeration chamber 40a and the second aeration chamber 40b. Wastewater enters the tank 11 through the influent inlet 30 and flows into the first chamber 40 where it is introduced to microbial organisms and aerated by the air diffuser 56. The wastewater is then forced through the first end 60a of the conical shaped opening 60 in the divider wall 42 by hydraulic displacement. The wastewater is again exposed to microbial organisms and aerated in the second aeration chamber 40b.

In passing from the first aeration chamber 40a to the second aeration chamber 40b, the wastewater undergoes significant treatment. Firstly, introducing the wastewater in the first chamber 40a to microbial organisms brings about a breakdown of complex organic compounds and produces compounds which are stable. Secondly, any solid matter present in the wastewater in the first aeration chamber 40a which cannot fit through the smaller end 60a of the divider wall opening 60 is forced to remain within the first aeration chamber 40a. Lastly, each of the air diffusers 56 produces a flow of air along either side of the divider wall 42 which causes a circular current in the water at the center of each chamber, 40a and 40b. A significant portion of solid matter which contacts the circular current is picked up by the current rather than allowed to pass through the opening 60 in the divider wall. The remaining wastewater passes through the opening 60 as a result of hydraulic displacement.

The monitoring float 58 attached to the central air manifold is configured to allow pressure to be broken during high water conditions and simultaneously activate the pressure controlled alarm 35.

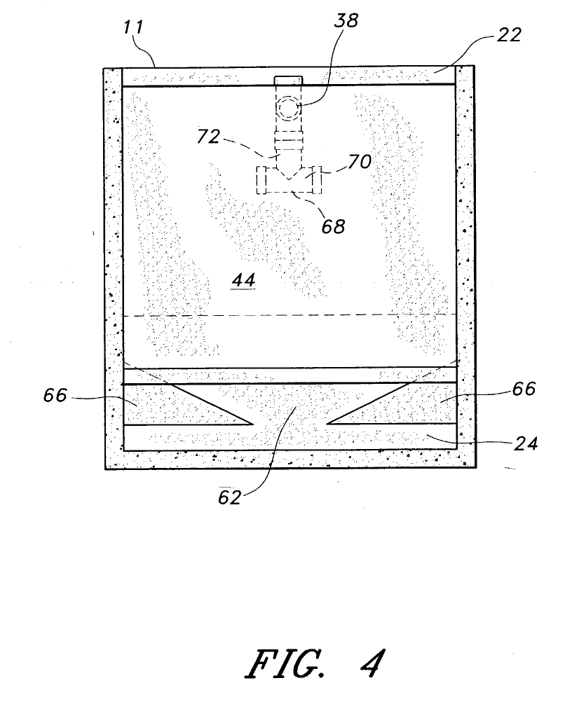

As can be more clearly seen in FIG. 4, the baffle 44 partially separates the second aeration chamber 40b from the clarification chamber 40c. As the baffle 44 does not extend to the horizontal bottom wall 12, a gap 62 is created between the second aeration chamber 40b and the clarification chamber 40c through which wastewater may pass.

The clarification chamber 40c has a sloped floor 64 and a downwardly inclined wedge 66 on either side of the sloped floor 64. The clarification chamber 40c is provided with a T-shaped wastewater clarifier conduit 68 which is attached to the effluent outlet 38. The T-shaped clarifier conduit 68 has a first vertical branch 72 which depends from the effluent outlet 38 and a second horizontal branch 70 which extends horizontally from the vertical branch 72. The T-shaped clarifier conduit 68 and the effluent outlet 38 are preferably 4-inch PVC tees which are attached directly to each other.

After a period of time, oxygen rich water enters the clarification zone 40c from the second aeration chamber 40b through the gap 62 beneath the baffle 44. Non-turbulent conditions within the clarification zone 40c allow the settling of sludge and attached microorganisms. The sloped floor 64 of the clarification chamber 40c and the wedges 66 direct the sludge and microorganisms which have settled, back through the gap 62, towards the center of the second aeration chamber 40b, which is the most turbulent area of the second chamber 40b. Thus, the sludge and microorganisms are more efficiently picked back up by the current and allowed to reseed the second chamber 40b.

The wastewater which remains in the clarification chamber 40c exits the tank 11 through the T-shaped clarifier conduit 68 and the effluent outlet 38. The horizontal branch 70 of the T-shaped clarifier conduit 68 is submersed below the surface of the wastewater to avoid sludge which has risen to the water's surface. In addition, the T-shape of the clarifier conduit 68, helps to prevent solid updraft. As can be seen more clearly in FIG. 4, the treated water must first flow horizontally through the horizontal branch 70, then vertically through the vertical branch 72, and then again horizontally through the effluent conduit 38 in order to leave the tank 11. Consequently, heavier particles floating within the wastewater are less likely to flow through the clarifier conduit 68, and the effluent conduit 38.

It is to be understood that the present invention is not limited to the embodiments described above, but encompasses any and all embodiments within the scope of the following claims.

I claim:

1. A wastewater treatment unit, comprising:
a tank having a horizontal bottom wall and an upright peripheral wall which extends from the horizontal bottom wall, said upright peripheral wall including two opposing sidewalls and first and second opposing endwalls, said second endwall including an upper vertical portion and a lower inclined portion, the tank having an open top and a hollow interior;
a divider wall disposed within the interior and extending between the opposing sidewalls, and spaced from said first endwall, said divider wall having a top end and a bottom end, said bottom end connecting with said bottom wall;
a baffle disposed within the interior and extending between the opposing sidewalls, and spaced from said second endwall, said baffle having a top end and a bottom end, said bottom end being spaced from said bottom wall;
wherein said divider wall and said first endwall define a first aeration chamber therebetween, said divider wall and said baffle define a second aeration chamber therebetween, and said baffle and said endwall define a clarification chamber therebetween; and
wherein the lower inclined portion of said second endwall defines a sloped floor for said clarification chamber so that sludge settling in said clarification chamber is directed to a central region of said second aeration chamber.

2. The wastewater treatment unit of claim 1, wherein said divider wall includes a conical shaped opening defined therethrough, said opening having a smaller end opening into said first chamber and an opposing larger end opening into said second chamber.

3. The wastewater treatment unit of claim 1 further including:
a central air manifold, said manifold being disposed upon the top end of said divider wall;
a pair of aeration pipes depending from said manifold, each said aeration pipe extending into one of said first or second aeration chambers;
an air diffuser platform connected to each said aeration pipe and extending to said bottom wall;
an air diffuser connected to each said air diffuser platform;
whereby air from said central air manifold is directed to said air diffusers through said aeration pipes for equally aerating each said firs and second aeration chambers.

4. The wastewater treatment unit of claim 3, further comprising:
a monitoring float attached to said air manifold and extending into said second aeration chamber; and
an air pressure alarm attached to said manifold, said float breaking pressure during high water conditions in order to activate said air pressure alarm.

5. The wastewater treatment unit of claim 1, wherein said clarification chamber further comprises a pair of wedges disposed on said sloped floor.

6. The wastewater treatment unit of claim 1, wherein said clarification chamber further comprises an effluent outlet attached to said second endwall for providing a conduit through which treated wastewater exits said tank.

7. The wastewater treatment unit of claim 6, wherein said clarification chamber comprises a T-shaped clarifier conduit extending normal to said effluent outlet, said clarifier conduit being configured to prevent solid updraft in treated wastewater exiting said tank.

8. The wastewater treatment unit of claim 1, wherein said tank further comprises a removable lid disposed over said peripheral wall, said lid having riser extending therefrom.

9. The wastewater treatment unit of claim 1, wherein said second aeration chamber has a larger volume than said first aeration chamber.

10. The wastewater treatment unit of claim 1, wherein said tank said divider wall, and said baffle are made from concrete.

11. The wastewater treatment unit of claim 1, wherein said tank, said divider wall, and said baffle are made from asphalt coated steel.

12. A wastewater treatment system comprising:
a tank having a horizontal bottom wall and an upright peripheral wall which extends from the horizontal bottom wall, said upright peripheral wall including two opposing sidewalls and first and second opposing endwalls, said second endwall including an upper vertical portion and a lower inclined portion, the tank having an open top and a hollow interior;
a divider wall disposed within said recess and spaced from said first endwall, said divider wall having a top end and a bottom end, said bottom end connecting with said bottom wall;
a baffle disposed within said recess and spaced from said second endwall, said baffle having a top end and a bottom end, said bottom end being spaced from said bottom wall;
a central air manifold disposed on the top end of said divider wall;
an aerator;
an air tube extending between and connecting said central air manifold and said aerator;
wherein said divider wall and said first endwall define a first aeration chamber therebetween, wherein said divider wall and said baffle define a second aeration chamber therebetween, and said baffle and said endwall define a clarification chamber therebetween;
wherein said lower inclined portion of said second endwall defines a sloped floor for said clarification chamber so that sludge settling in said clarification chamber is directed to a central region of said second aeration chamber; and
wherein said aerator is adapted for being placed above ground level and said tank is adapted for being placed below ground level.

13. The wastewater treatment system of claim 12 further comprising:
a pressure controlled alarm; and
a supplementary tube extending between and connecting said alarm and said air tube.
